(19) United States
(12) Patent Application Publication
(10) Pub. No.: US 2017/0001380 A1
(43) Pub. Date: Jan. 5, 2017

(54) SYSTEMS AND METHODS OF CURING ADDITIVE MANUFACTURED MATERIALS

(71) Applicants: Zhen XIAO, Beijing (CN); EMPIRE TECHNOLOGY DEVELOPMENT LLC, Wilmington, DE (US)

(72) Inventor: Zhen XIAO, Beijing (CN)

(73) Assignee: EMPIRE TECHNOLOGY DEVELOPMENT LLC, Wilmington, DE (US)

(21) Appl. No.: 15/125,917

(22) PCT Filed: Mar. 13, 2014
(86) PCT No.: PCT/CN2014/073410

§ 371 Date: Sep. 13, 2016

(51) Int. Cl. B29C 67/00; B33Y 30/00; B33Y 50/02; B33Y 10/00

(52) U.S. Cl. CPC B29C 67/0088; B33Y 10/00; B33Y 30/00; B33Y 50/02

(57) ABSTRACT

Methods of curing a photo-curable material, photo-curing devices, apparatuses for curing a photo-curable material, and methods of forming a photo-curing device are disclosed. A method of curing a photo-curable material may include placing a photo-curing device having a magnetic body adjacent to the photo-curable material and controlling movement of the photo-curing device with at least one magnet. A photo-curing device may include a magnetic body and at least one light source positioned at one or more locations on the magnetic body and configured to emit electromagnetic radiation. The magnetic body may be configured to be movable adjacent to a photo-curable material by at least one magnet.

### BACKGROUND

Adding a new component to a previously manufactured object may require that the new component be separately produced and subsequently affixed to the previously manufactured object. However, the new component may be difficult to affix depending on the shape and/or size of the new component. In addition, the shape and/or size of the previously manufactured object may cause similar issues when affixing a new component. For example, an opening in the previously manufactured object may be too small for the new component and thus may require the previously manufactured object to be disassembled. Disassembly may be time-consuming, costly, damaging to the previously manufactured object, and/or the like.

### SUMMARY

In an embodiment, a method of curing a photo-curable material may include placing a photo-curing device having a magnetic body adjacent to the photo-curable material and controlling movement of the photo-curing device with at least one magnet.

In an embodiment, a photo-curing device may include a magnetic body and at least one light source positioned at one or more locations on the magnetic body and configured to emit electromagnetic radiation. The magnetic body may be configured to be movable adjacent to a photo-curable material by at least one magnet.

In an embodiment, a photo-curing device may include a magnetic body and at least one reflective portion positioned at one or more locations on the magnetic body and configured to reflect electromagnetic radiation. The magnetic body may be configured to be movable adjacent to a photo-curable material by at least one magnet.

In an embodiment, an apparatus for curing a photo-curable material may include at least one photo-curing device. The photo-curing device may include a magnetic body and at least one light source positioned at one or more locations on the magnetic body and configured to emit electromagnetic radiation. The magnetic body may be configured to be movable adjacent to a photo-curable material by at least one magnet.

In an embodiment, an apparatus for curing a photo-curable material may include at least one photo-curing device. The photo-curing device may include a magnetic body and at least one reflective portion positioned at one or more locations on the magnetic body and configured to reflect electromagnetic radiation. The magnetic body may be configured to be movable adjacent to a photo-curable material by at least one

In an embodiment, a method of forming a photo-curing device may include providing a magnetic body configured to be movable by at least one magnet and positioning at least one light source at one or more locations on the magnetic body. The at least one light source may be configured to emit electromagnetic radiation.

In an embodiment, a method of forming a photo-curing device may include providing a magnetic body configured to be movable by at least one magnet and positioning at least one reflective portion at one or more locations on the magnetic body such that the at least one reflective portion reflects electromagnetic radiation.

### BRIEF DESCRIPTION OF THE DRAWINGS

FIG. 1A depicts an illustrative photo-curing device according to a first embodiment.

FIG. 1B depicts an illustrative photo-curing device according to a second embodiment,

FIG. 2 depicts illustrative beams of electromagnetic radiation as emitted from a light source according to an embodiment.

FIG. 3 depicts a block diagram of an illustrative apparatus for curing a photo-curable material according to an embodiment.

FIG. 4 depicts a cutaway side view of an illustrative previously manufactured object with new components according to an embodiment.

FIG. 5 depicts a cutaway side view of a previously manufactured object with an illustrative photo-curing device inserted therein according to an embodiment.

FIG. 6 depicts a flow diagram of an illustrative method of curing a photo-curable material according to an embodiment.

FIG. 7 depicts a flow diagram of an illustrative method of forming a photo-curing device according to a first embodiment.

FIG. 8 depicts a flow diagram of an illustrative method of forming a photo-curing device according to a second embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, a “previously manufactured object” is an object or a portion thereof that has been manufactured or partially manufactured prior o application of the various apparatuses and methods described herein. In some cases, a previously manufactured object may require additional components to be constructed on at least a portion thereof. In some embodiments, a previously manufactured object may be a three dimensional (3D) printed object.

As used herein, a “photo-curable material” refers to any material that can undergo a curing reaction in response to an irradiation of electromagnetic energy. The photo-curable material may generally be a solid material (such as a powder), a liquid material, or a semisolid material (such as a partially molten solid material or a paste) such that it can be placed adjacent to a previously manufactured object, as described herein. In some embodiments, the photo-curable material may be a resin, particularly a photosensitive resin, including any resin for which thermosetting may be performed after photo-curing. An illustrative photosensitive resin may be, but is not limited to, a two-photon excitable resin. Such a resin may generally be a photosensitive material or photoresist that undergoes two-photon polymerization via two-photon absorption and subsequent polymerization when exposed to certain electromagnetic radiation. Other illustrative photo-sensitive materials may include, but are not limited to, an inorganic-organic hybrid polymer, a photosensitive resist material, and a photoinitiator. An inorganic-organic hybrid polymer may generally be a polymer having one or more inorganic regions and one or more organic regions. Each inorganic region may include one or more inorganic elements such as, for example, silicon, boron, aluminum, phosphorous, tin, lead, any transition metal, a transition metal, a lanthanide; an actinide, and/or the like. In some embodiments, an inorganic region may include M-O-M units, with M representing silicon, boron, aluminum, phosphorous, tin, lead, a transition metal, a lanthanide, an actinide, and/or the like and O representing oxygen. Each organic region may include one or more of for example, carbon, hydrogen, oxygen, nitrogen, sulfur, a halogen, and/or the like. A photosensitive resist material may generally be any resist material used for photolithography, as is commonly known by those having ordinary skill in the art. A photoinitiator is a molecule that, upon absorption of electromagnetic radiation at a specific wavelength, produces one or more reactive species capable of catalyzing polymerization, cross-linking, and/or curing reactions.

The present disclosure relates generally to a photo-curing device that is movable adjacent to a previously manufactured object via a magnetic field spatial control system. The photo-curing device may generally be configured to cure a photo-curable material located adjacent to the previously manufactured object such that the photo-curable material is cured on the previously manufactured object. Such a photo-curable material would be otherwise difficult to cure and/or form into various new components, particularly in instances where the new components are located in tight spaces on or in the previously manufactured object.

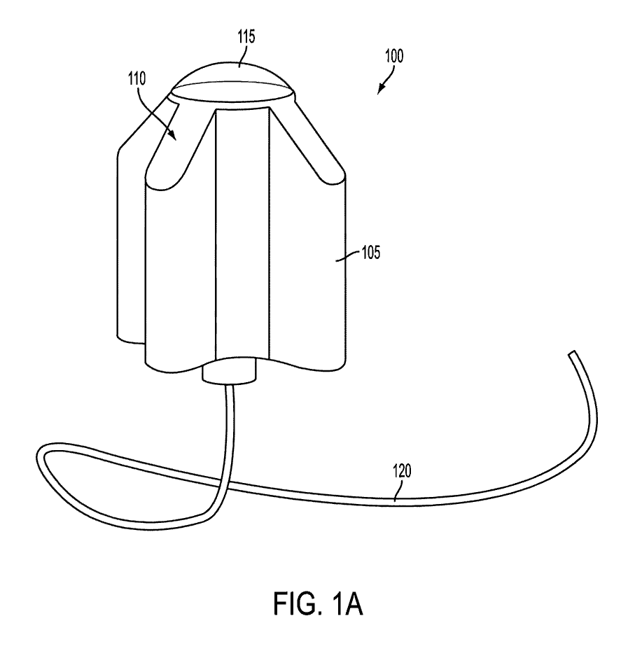

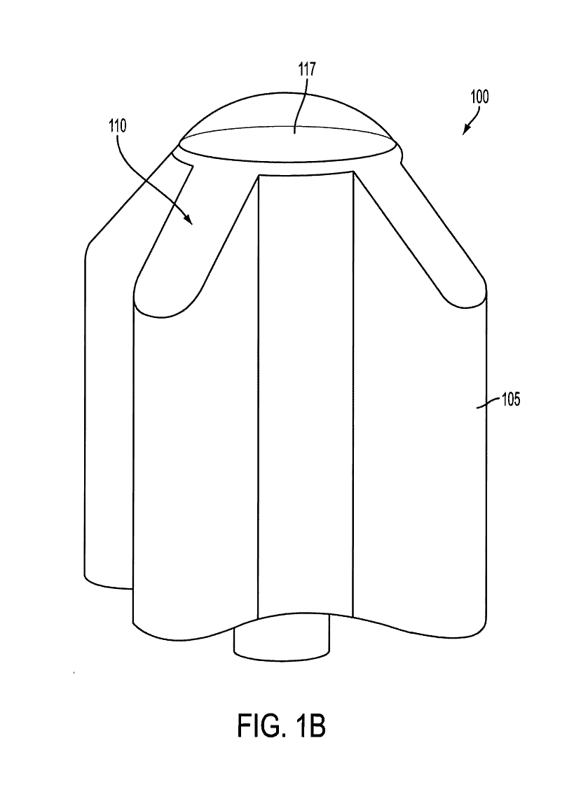

FIG. 1A depicts an illustrative photo-curing device, generally designated 100, according to an embodiment The photo-curing device 100 may generally include a body 105 and at least one light source 115. As described in greater detail herein, the photo-curing device 100 may be movable via magnetic field spatial control. Accordingly, the photo-curing device 100 may be movable by at least one magnet. The photo-curing device 100 may generally be configured to be placed adjacent to a previously manufactured object, such as, for example, inside a cavity of a previously manufactured object. The photo-curing device 100 may also be configured to be placed adjacent to a photo-curable material such that the photo-curing device cures the photo-curable material on the previously manufactured object.

In order to be movable via magnetic field spatial control, at least a portion of the body 105 may be magnetic. Accordingly, the body 105 may be a magnetic body constructed of a magnetic material that responds to a magnetic field. Illustrative magnetic materials ay include, but are not limited to, materials that include at least one magnetic particle, at least one magnetizable particle, a magnetic compound, a magnetizable compound, at least one magnetic nano-particle, at least one magnetizable nano-particle, and/or the like. A magnetizable particle or a magnetizable compound may refer to a metallic particle or a compound that becomes magnetized in the presence of an external magnetic field. A magnetic nano-particle may be a particle having a size in any dimension of about 1 nm to about 999 nm. Magnetic material may include a material that exhibits a magnetic moment in the absence of an external magnetic field and/or exhibits a magnetic moment in the presence of an external magnetic field. In some embodiments, the body 105 may contain a composite or a composition having at least one magnetic component and at least one other component. Particular examples of magnetic materials include, but are not limited to, materials containing iron, cobalt, nickel, iron oxide, ferrites of cobalt, ferrites of zinc, and/or the like.

In some embodiments, the body 105 may be a solid magnetic material. In other embodiments, the body 105 may be coated with a magnetic material, such as, for example, a body having a core made of a first material and a coating made of a second material, where the second material is a magnetic material. In such embodiments, the core may be made of any material and is not limited by this disclosure.

In various embodiments, the body 105 may be formed such that it contains one or more structural features 110. Such structural features 110 are not limited by this disclosure, and may generally be structural features that allow the body 105 to be movable adjacent to a photo-curable material, as described in greater detail herein. For example, illustrative structural features 110 may include, but are not limited to, a wing, a rudder, a flap, a protuberance, and/or the like.

The at least one light source 115 may be positioned at any location on the body 105. In some embodiments, the at least one light source 115 may be positioned such that it directs electromagnetic radiation toward a target area, as described in greater detail herein. Various light sources 115 may be located at a single location on the body 105 or may be positioned at various locations on the body.

The at least one light source 115 may generally be configured to emit electromagnetic radiation therefrom. In some embodiments, the at least one light source 115 may be configured to emit electromagnetic radiation only when directed, such as by a control device, as described in greater detail herein. In other embodiments, the at least one light source 115 may be configured to continuously emit electromagnetic radiation. In some embodiments, the at least one light source 115 may be configured to emit electromagnetic radiation at an interval. As described in greater detail herein, the at least one light source 115 may be powered by a power source. The power source may be an external device or may be integrated in the body 105.

Illustrative light sources 115 may include, but are not limited to, an ultraviolet light emitting diode, a laser diode, a near-infrared titanium sapphire femtosecond laser oscillator, and/or the like. An ultraviolet light emitting diode (LED) may generally be any semiconductor device configured to emit ultraviolet (UV) light. Those with ordinary skill in the art will recognize suitable UV LED devices for use as a portion of the photo-curing device 100. A laser diode may generally be an electrically pumped semiconductor laser. An active medium in the laser diode may be formed by a p-n junction of a semiconductor diode similar to the light-emitting diode. In particular embodiments, the laser diode may be a femtosecond laser diode. Such a diode may generate a laser in femtosecond-length pulses. A near-infrared titanium sapphire femtosecond laser oscillator, which is also known as a Ti:sapphire laser, a titanium-sapphire laser, or a Ti:sapphire, may generally be a tunable laser that emits near-infrared light. The near infrared light may generally be any light emitted that has a wavelength of about 650 nm to about 900 nm. For example, the wavelength may be about 650 nm, about 700 nm, about 750 nm, about 800 nm, about 850 nm, about 900 nm, or any value or range between any two of these values (including endpoints).

In some embodiments, the at least one light source 115 may generally be configured to emit electromagnetic radiation having a wavelength of about 100 nm to about 900 nm. For example, the at least one light source 115 may emit electromagnetic radiation at a wavelength of about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, or any value or range between any two of these values (including endpoints). The electromagnetic radiation emitted by the at least one light source 115 may cause at least a portion of a photo-curable material to cure, as described in greater detail herein.

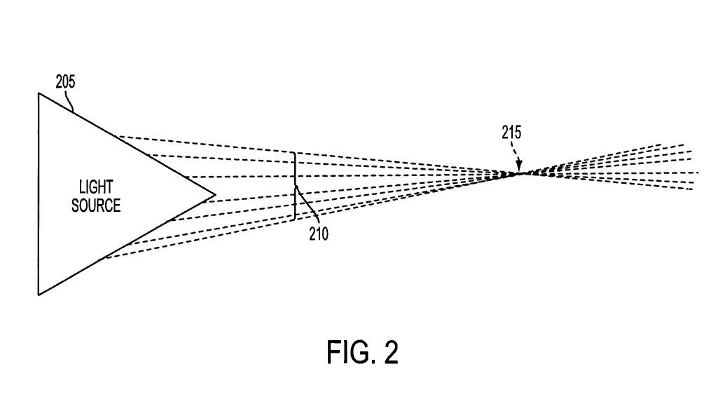

As shown in FIG. 2, electromagnetic radiation 210 emitted from the at least one light source 205 may have a focal point 215. As will be recognized by those with ordinary skill in the art, the focal point 215 may be a location at which the electromagnetic radiation 210 is focused. The amount of energy of the electromagnetic radiation 210 at the focal point 215 may be greater than or equal to a threshold curing value. The amount of energy of the electromagnetic radiation 210 at any location other than the focal point 215, such as, for example, on the photo-curable material at a location other than the focal point, may be less than the threshold curing value. The threshold curing value is defined herein as an amount of energy necessary to cure the photo-curable material. Thus, if an amount of energy is less than the threshold curing value, the photo-curable material will not cure. Conversely, if an amount of light energy is greater than or equal to the threshold curing value, the photo-curable material will cure. Accordingly, the photo-curing device 100 (FIG. 1) may be configured to cure the photo-curable material only at the focal point 215 of the at least one light source 205.

Referring back to FIG. 1A, in some embodiments, the photo-curing device 100 may include a communications/power link 120. The communications/power link 120 may generally provide communications between the photo-curing device 100 and an external device, such as, for example, an external power source and/or a control device, as described in greater detail herein. The communications/power link 120 is not limited by this disclosure, and may be any wired or wireless device configured to provide communications to the photo-curing device 100. Thus, in some embodiments, the communications/power link 120 may be a physical cable, such as a fiber optic cable, a data cable, an electrically conductive cable, and/or the like. In other embodiments, the communications/power link 120 may include one or more wireless transceivers located on the photo-curing device 100 and the external device. The one or more wireless transceivers may be configured to transmit signals via any wireless protocol and/or may be configured to provide power via electromagnetic induction.

FIG. 1B depicts the photo-curing device 100 according to a second embodiment. The photo-curing device 100 may generally be similar to the device depicted in FIG. 1A, but may contain at least one reflective portion 117 instead of or in addition to the at least one light source 115 (FIG. 1A). Accordingly, the photo-curing device 100 may include a body 105, such as a magnetic body, and/or one or more structural features 110, as described in greater detail herein. Furthermore, the photo-curing device 100 may be movable via magnetic field spatial control.

The at least one reflective portion 117 may generally be positioned at any location on the body 105. In some embodiments, the at least one reflective portion 117 may be positioned at one or more locations on the body 105. The at least one reflective portion 117 may be configured to reflect electromagnetic radiation, such as, for example, from at least one external light source. Reflection of the electromagnetic radiation may cause at least a portion of the photo-curable material to cure, as described in greater detail herein.

Illustrative reflective portions may include, but are not limited to, a mirror, a prism, a terminal end of an optical fiber, and/or the like. A mirror may generally be any reflective surface, such as, for example, reflective-backed glass, reflective polymeric sheeting, a reflective metal foil, and/or the like. In some embodiments, the mirror may be a concave mirror In some embodiments, the mirror may be a convex minor. In some embodiments, the mirror may be a polygonal minor having a plurality of facets with at least one rotational position. Thus, the mirror may rotate to reflect electromagnetic radiation and/or focus the electromagnetic radiation to cure the photo-curable material, as described in greater detail herein. The polygonal mirror may also be configured as a light tunnel such that it has mirrored walls and a polygonal cross section. The polygonal mirror may reflect electromagnetic radiation from a first end (source end) to a second end (plate end). In some embodiments, the at least one reflective portion 117 may be configured to selectively reflect electromagnetic radiation. Such a selective reflection may be necessary to ensure that the photo-curable material is cured at a proper time and/or location.

While FIG. 1B does not depict the communications/power link 120 depicted in FIG. 1A, those with ordinary skill in the art will recognize that the communications/power link may be present. For example, in embodiments where the reflective portion 117 is a terminal end of a fiber optic cable, the communications/power link 120 may be the fiber optic cable.

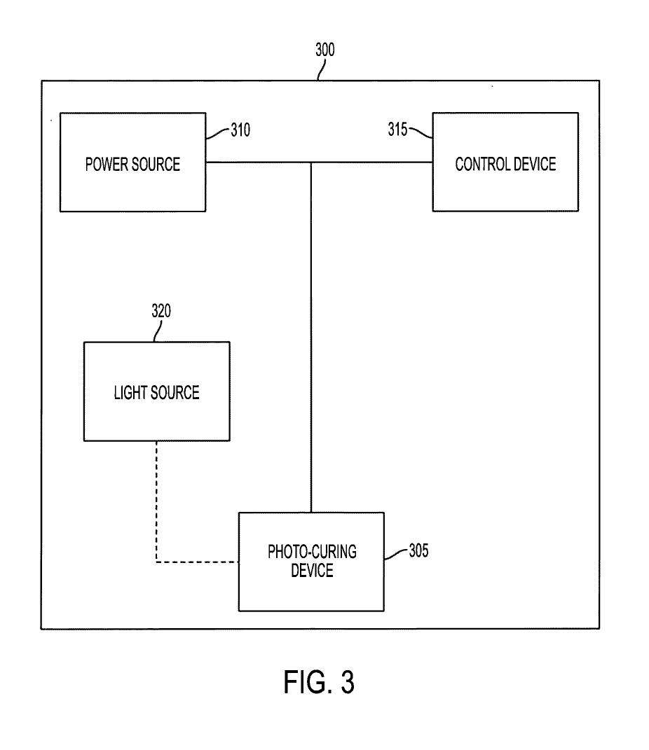

FIG. 3 depicts a block diagram of an apparatus, generally designated 300, for curing a photo-curable material according to an embodiment. The apparatus 300 may generally include a photo-curing device 305. The photo-curing device 305 may be any photo-curing device, such as those described herein with respect to FIGS. 1A and 1B. In some embodiments, the apparatus 300 may include a power source 310. In some embodiments, the apparatus 300 may include a control device 315. In embodiments where the photo-curing device includes at least one reflective portion, the apparatus may include a light source 320.

The power source 310 may be located externally to the photo-curing device 305 or may be integrated with the photo-curing device. When the power source 310 is external to the photo-curing device, it may also be located externally to the previously manufactured object such that only the photo-curing device is inserted adjacent to (or inside) the previously manufactured object.

The power source 310 may generally be configured to provide electrical power to the photo-curing device 305. In some embodiments, the power source 310 may provide power to the photo-curing device 305 via the communications/power link 120 (FIG. 1A). In some embodiments, the power source 310 may wirelessly transmit power to the photo-curing device 305 via electromagnetic induction. Illustrative power sources may include, but are not limited to, a battery, a capacitor, a generator, and/or the like.

The control device 320 may be located at a location that is external to the photo-curing device 305 or may be integrated with the photo-curing device. When the control device 320 is external the photo-curing device, it may also be located externally to the previously manufactured object such that only the photo-curing device is inserted adjacent to (or inside) the previously manufactured object.

The control device 320 may generally be configured to provide at least one control signal to the photo-curing device 305. In some embodiments, the control device 320 may provide at least one control signal to the photo-curing device 305 via the communications/power link 120 (FIG. 1A). In some embodiments, the control device 320 may wirelessly transmit at least one control signal to the photo-curing device 305 via any wireless transmission protocol now known or later developed. A control signal may generally direct the photo-curing device 305 and/or portions thereof to complete at least one instruction. For example, the control signal may direct the light source 115 (FIG. IA) to emit electromagnetic radiation, as described in greater detail herein. In some embodiments, the control signal may direct the light source 115 (FIG. 1A) to modulate the emitted electromagnetic radiation, as described in greater detail herein. In some embodiments, the control signal may direct the reflective portion 117 (FIG. 1B) to reflect radiation, to focus reflected radiation, to move, and/or the like.

The light source 320 may generally be present in embodiments where the photo-curing device 305 includes at least one reflective portion 117 (FIG. 1B). The light source 320 may be a portion of the apparatus 300 or may be a standalone device that is separate from the apparatus. The light source 320 may be remotely located from the photo-curing device 305 and may direct electromagnetic radiation towards the photo-curing device. For example, the light source 320 may be external to a previously manufactured object and may direct electromagnetic radiation through an opening in the previously manufactured objected towards the photo-curing device 320 located inside a cavity of the previously manufactured object, as described in greater detail herein.

Illustrative light sources may include, but are not limited to, an ultraviolet light emitting diode, a laser diode, a near-infrared titanium sapphire femtosecond laser oscillator, and/or the like. In some embodiments, the light source 320 may be a naturally occurring light source. An ultraviolet light emitting diode (LED) may generally be any semiconductor device configured to emit ultraviolet (UV) light. Those with ordinary skill in the art will recognize suitable UV LED devices for use as a portion of the light source 320. A laser diode may generally be an electrically pumped semiconductor laser. An active medium in the laser diode may be formed by a p-n junction of a semiconductor diode similar to the light-emitting diode. In particular embodiments, the laser diode may be a femtosecond laser diode. Such a diode generates laser light in femtosecond-length pulses. A near-infrared titanium sapphire femtosecond laser oscillator may generally be a tunable laser that emits near-infrared light. The near infrared light may generally be any light emitted that has a wavelength of about 650 nm to about 900 nm. For example the wavelength may be about 650 nm, about 700 nm, about 750 nm, about 800 nm, about 850 nm, about 900 nm, or any value or range between any two of these values (including endpoints).

The light source 320 may generally be configured to emit electromagnetic radiation having a wavelength of about 100 nm to about 900 nm. For example, the light source 320 may emit electromagnetic radiation at a wavelength of about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, or any value or range between any two of these values (including endpoints). The electromagnetic radiation emitted by the light source 320 may cause at least a portion of a photo-curable material to cure, as described in greater detail herein.

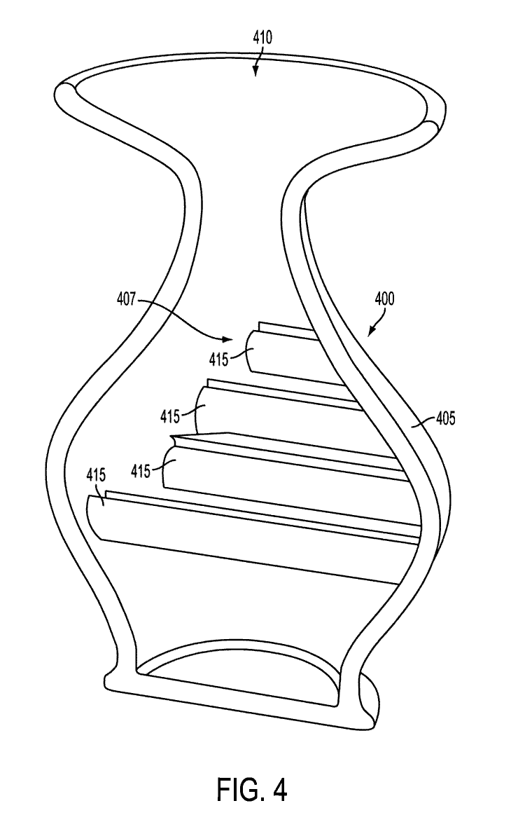

FIG. 4 depicts a cutaway side view of an illustrative object 400, such as a previously manufactured object, according to an embodiment. The object 400 may be any size and/or shape. In some embodiments, the object 400 may be a three dimensional (3D) printed object. The object 400 may include a body 405. At least one new component 415 may be constructed on the body 405 of the object. For example, in some embodiments, the new component 415 may be constructed on an inside portion of the body 405, such as within a cavity 407 of the body. In some embodiments, the body 410 may contain an opening 410 therein such that the cavity 407 can be accessed. In some embodiments, the new portion 415 may be sized and/or shaped such that it cannot be formed by conventional methods. Rather, the new portion 415 may be formed via methods described herein.

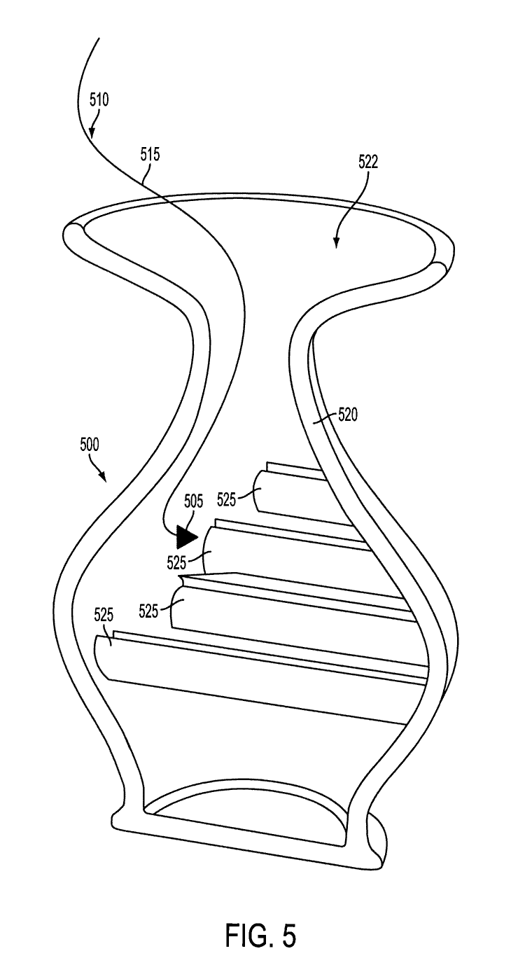

As shown in FIG. 5, at least a portion of the apparatus 510, such as the photo-curing device 505, may be inserted adjacent to the body 520 of the object 500. For example, the photo-curing device 505 may be placed inside a cavity 522 of the object 500. The communications/power link 515 may extend out of the cavity 522 to connect various components to the photo-curing device 505, as described in greater detail herein. The photo-curing device 505 may be positioned adjacent to the photo-curable material 525 and signaled to cure the photo-curable material.

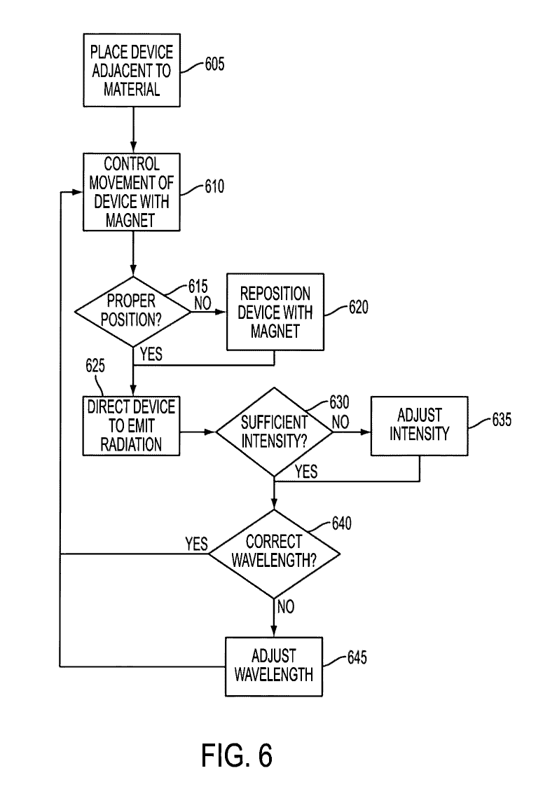

FIG. 6 depict flow diagram of an illustrative method of curing a photo-curable material, such as a photo-curable material located adjacent to a previously manufactured object. The method may include placing 605 at least a portion of the apparatus, such as the photo-curing device, adjacent to the photo-curable material. One or more movements of the photo-curing device may be controlled 610, such that, for example, the photo-curing device is properly positioned to cure desired areas of the photo-curable material. Controlling 610 movement of the photo-curing device may also include determining a movement path of the photo-curing device based upon a desired shape and/or size of the photo-curable material. Controlling 610 movement of the photo-curing device may further include determining a movement path of the photo-curing device based upon the shape of the previously manufactured object, the size of the previously manufactured object, and/or one or more features of the previously manufactured object. Controlling 610 may further include directing the photo-curing device to move along the determined movement path.

Placing 605 and controlling 610 movement of the photo-curing device may generally be completed by one or more magnets, such as via magnetic field spatial control.

For example, a plurality of magnets may be placed at one or more positions adjacent to the object to create a magnetic field. The magnetic properties of the photo-curing device may cause the device to respond to the magnetic field. Accordingly, the magnetic field can be manipulated (for example, changing direction, intensity, spatial location, and/or the like), which causes the photo-curing device to move in response to such changes. Minute changes to the magnetic field may cause similar minute changes in the positioning and location of the photo-curing d ice, which allows for the photo-curing device to cure photo-curable material with high precision. Furthermore, movement of the photo-curing device in response to changes in the magnetic field can be predicted such that the magnetic field can be adjusted to produce desired precise movements of the photo-curing device. For example, a computer program may determine various X, Y, and Z coordinates of a movement and a positioning of the photo-curing device and may direct the magnets to adjust the magnetic field accordingly.

The type of magnet used to control the magnetic field (and correspondingly, the photo-curing device) not limited by this disclosure. Those with ordinary skill in the art will recognize certain magnets that are suitable for precise control of the magnetic field produced by the magnets. In some embodiments, the magnet may be an electromagnet. Thus, various parameters of the electromagnet can be adjusted to modify the electromagnetic field produced therefrom, such as, for example, the positioning and/or orientation of the electromagnetic and/or the amount of voltage applied to the electromagnet to produce the electromagnetic field.

The positioning and/or location of the photo-curing device may be determined 615 to ensure proper and accurate curing of the photo-curable material. Positioning and/or location may be dependent upon a positioning and/or location of the light source and/or the reflective portion such that the electromagnetic radiation is appropriately directed. If the photo-curing device is not properly positioned, it may be repositioned 620, which may include adjusting the magnetic field, as described herein.

The photo-curing device may be directed 625 to emit or reflect electromagnetic radiation. For example, the photo-curing device may be directed 625 by sending one or more signals to the photo-curing device, such as signals from the control device, as described in greater detail herein. The one or more signals may cause the photo-curing device to emit or reflect electromagnetic radiation. In some embodiments, the radiation may be emitted or reflected at one or more intervals, at a particular intensity, for a particular duration, and/or the like. Direction 625 of the photo-curing device to emit or reflect radiation may be completed such that the radiation is directed towards the photo-curable material to be cured.

In various embodiments, an intensity and/or a wavelength of at least one beam of the electromagnetic radiation may be controlled. Such control may include determining 630 whether the intensity is sufficient and adjusting 635 the intensity accordingly. Control may also include determining 640 whether the wavelength of the electromagnetic radiation is correct and adjusting 645 the wavelength accordingly. The method may be repeated at process 610 any number of times until the new components have been created and/or all of the photo-curable material has been cured.

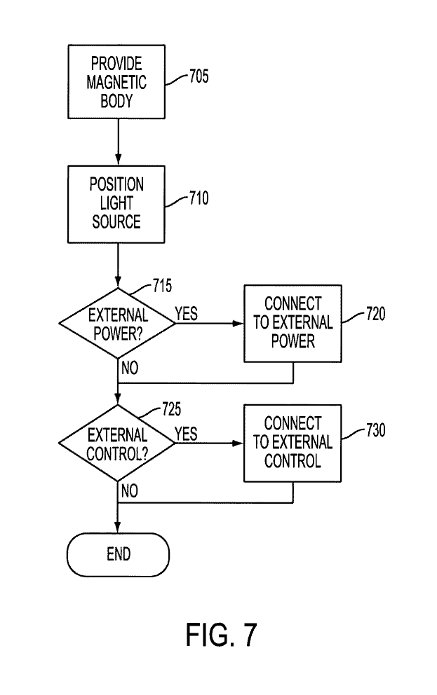

FIG. 7 depicts a flow diagram of an illustrative method of forming a photo-curing device according to a first embodiment. The method may include providing 705 a body, such as a magnetic body as described herein. The body may generally be configured to be movable by at least one magnet. At least one light source may be positioned 710 on one or more locations on the body, and the light source is configured to emit electromagnetic radiation, as described in greater detail herein.

A determination 715 may be made as to whether an external power source is necessary, which may be based upon whether the photo-curing device requires power, whether the photo-curing device contains an internal power source, and/or the like. If an external power source is needed, the photo-curing device may be connected 720 to the external power source such that the external power source provides electrical power to the photo-curing device. Connection 720 may be via the communications/power link, for example.

A determination 725 may be made as to whether an external control device is necessary, which may be based upon whether the photo-curing device requires external control to emit electromagnetic radiation. If an external control device is needed, the photo-curing device may be connected 730 to the external control device such that the external control device transmits one or more signals to the photo-curing device. Connection 730 may be via the communications/power link, for example.

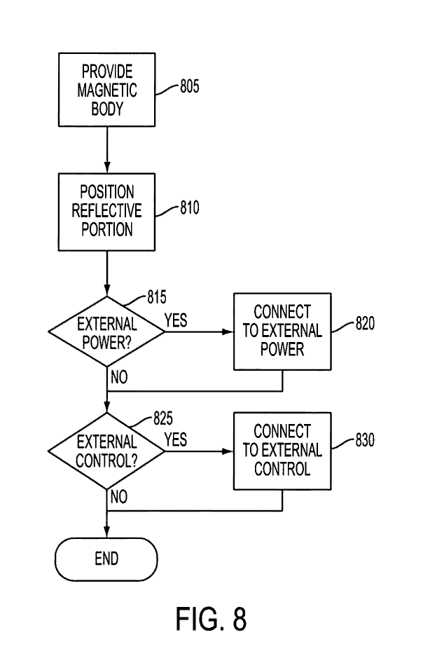

FIG. 8 depicts a flow diagram of an illustrative method of forming a photo-curing device according to a second embodiment. The method may include providing 805 a body, such as a magnetic body as described herein. The body may generally be configured to be movable by at least one magnet. At least one reflective portion may be positioned 810 on and/or integrated with one or more portions of the body. The at least one reflective portion may be configured to reflect electromagnetic radiation, as described in greater detail herein.

A determination 815 may be made as to whether an external power source is necessary, which may be based upon whether the photo-curing device requires power, whether the photo-curing device contains an internal power source, and/or the like. If an external power source is needed, the photo-curing device may be connected 820 to the external power source such that the external power source provides electrical power to the photo-curing device. Connection 820 may be via the communications/power link, for example.

A determination 825 may be made as to whether an external control device is necessary, which may be based upon whether the photo-curing device requires external control to reflect electromagnetic radiation. If an external control device is needed, the photo-curing device may be connected 830 to the external control device such that the external control device transmits one or more signals to the photo-curing device. Connection 830 may be via the communications/power link, for example.

### EXAMPLES

### Example 1

### Forming A Photo-Curing Device

A photo-curing device will be formed by providing 1 gram of a magnetizable iron-based compound and forming the compound into a magnetic body. A single near-infrared titanium sapphire femtosecond laser oscillator will be affixed to a first end of the magnetic body and a 1 meter long insulated copper cable configured to transmit control signals and provide electrical power will be affixed to a second end of the magnetic body. The insulated copper cable will be joined with an 8 volt battery that provides power and a computing device that provides control signals to the photo-curing device.

The resulting apparatus containing the photo-curing device, the battery, and the computing device will be provided to plastics manufacturers to assist with forming various components inside or on previously manufactured parts. The photo-curing device is small and can be positioned to cure small areas inside or on the pre-manufactured parts.

### Example 2

### Curing A Material

The apparatus as described with respect to Example 1 will be used to cure a liquid two photon excitable resin inside a previously manufactured part. The liquid two photon excitable resin will be poured into an opening of the previously manufactured part such that it fills a cavity within the part. The photo-curing device will be placed in the liquid two photon excitable resin.

The computing device will be provided with a computer-aided design program file that contains the dimensions of the previously manufactured part and various dimensions of the new components to be formed of the liquid two photon excitable resin. The computing device will calculate various coordinates for locations inside the cavity that the photo-curing device will traverse. The computing device will also determine a signal pattern for signaling the photo-curing device to emit electromagnetic radiation at particular times. The computing device will direct 4 electromagnets placed around the circumference of the previously manufactured part to adjust such that the electromagnetic field produced by the electromagnets causes the photo-curing device to traverse according to the calculated coordinates.

When signaled by the computing device, the near-infrared titanium sapphire femtosecond laser oscillator will emit a laser having a wavelength of 800 nm in 10 femtosecond bursts. The laser will provide a sufficient amount of energy at its focal point to cause the resin at the focal point to cure. The electromagnetic field will be adjusted to cause the photo-curing device to move around the cavity according to the calculated coordinates. The laser oscillator will emit the laser when signaled. This will continue until the new components have been completely formed. Once they have been formed, the electromagnetic field will be turned off, and the photo-curing device will be removed from the cavity. A remaining amount of the resin will be drained from the cavity and reused for future component curing.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “ a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of curing a photo-curable material, the method comprising:
placing a photo-curing device comprising a magnetic body adjacent to the photo-curable material; and
controlling movement of the photo-curing device with at least one magnet.

2. The method of claim 1, further comprising:
positioning the photo-curing device with the at least one magnet such that the photo-curing device directs electromagnetic radiation towards a portion of the photo-curable material.

3. The method of claim 2, further comprising:
directing the photo-curing device to emit at least one beam of electromagnetic radiation towards the portion of the photo-curable material.

4. The method of claim 2, further comprising:
directing the photo-curing device to reflect at least one beam of electromagnetic radiation emitted by an external radiation source towards the portion of the photo-curable material.

5. The method of claim 2, further comprising:
controlling at least one of an intensity and a wavelength of at least one beam of the electromagnetic radiation at a portion of the photo-curable material.

6. The method of claim 1, wherein controlling movement of the photo-curing device comprises:
determining a movement path of the photo-curing device based upon at least one of a desired shape of the photo-curable material, a desired size of the photo-curable material, a shape of an object containing the photo-curable material, a size of the object, and one or more features of the object; and
directing the photo-curing device along the movement path.

7. The method of claim 1, wherein placing the photo-curing device comprises placing adjacent to a photo-curable material including one or more of a liquid photo-curable material, a semi-solid photo-curable material, a paste, a powder, a photosensitive resin, a two-photon excitable resin, an inorganic-organic hybrid polymer, a photosensitive resist material and a photoinitiator.

8.-15. (canceled)

16. A photo-curing device comprising:
a magnetic body; and
at least one light source positioned at one or more locations on the magnetic body and configured to emit electromagnetic radiation,
wherein the magnetic body is configured to be movable adjacent to a photo-curable material by at least one magnet.

17. (canceled)

18. The photo-curing device of claim 16, wherein a remotely connected external control device in operable communication with the photo-curing device provides at least one control signal to the photo-curing device.

19. The photo-curing device of claim 18, wherein the at least one control signal directs the at least one light source to emit electromagnetic radiation.

20. The photo-curing device of claim 16, wherein the at least one light source comprises one or more of an ultraviolet light emitting diode, a laser diode, a femtosecond laser diode and a near-infrared titanium sapphire femtosecond laser oscillator.

21.-23. (canceled)

24. The photo-curing device of claim 16, wherein the at least one light source is configured to emit the electromagnetic radiation at a wavelength of about 100 nanometers to about 900 nanometers.

25. The photo-curing device of claim 16, wherein the electromagnetic radiation is configured to cure at least a portion of the photo-curable material.

26. The photo-curing device of claim 16, wherein the electromagnetic radiation has a curing value that is greater than or equal to a threshold curing value of the photo-curable material at a focal point of the electromagnetic radiation.

27. The photo-curing device of claim 26, wherein the electromagnetic radiation is configured to cure the photo-curable material at the focal point.

28. The photo-curing device of claim 16, wherein the electromagnetic radiation has a curing value that is less than a threshold curing value of the photo-curable material at a location on the photo-curable material other than a focal point of the electromagnetic radiation.

29. The photo-curing device of claim 16, wherein the photo-curing device is configured to be placed inside an object containing the photo-curable material.

30. The photo-curing device of claim 29, wherein the object is a three dimensional printed object.

31. The photo-curing device of claim 16, wherein the photo-curing device is configured to be placed adjacent to an object containing the photo-curable material.

32. The photo-curing device of claim 31, wherein the object is a three dimensional printed object.

33. The photo-curing device of claim 16, further comprising:
at least one reflective portion positioned at one or more locations on the magnetic body and configured to reflect the electromagnetic radiation.

34.-91. (canceled)

92. A method of forming a photo-curing device, the method comprising:
providing a magnetic body configured to be movable by at least one magnet; and
positioning at least one light source at one or more locations on the magnetic body, wherein the at least one light source is configured to emit electromagnetic radiation.

93. The method of claim 92, further comprising:
coupling the photo-curing device to an external power source configured to provide electrical power to the photo-curing device.

94. The method of claim 92, further comprising:
coupling the photo-curing device to an external control device configured to provide at least one control signal to the photo-curing device.

95. The method of claim 92, wherein positioning the at least one light source comprises positioning an ultraviolet light emitting diode.

96. The method of claim 92, wherein positioning the at least one light source comprises positioning a laser diode.

97. The method of claim 92, further comprising
positioning at least one reflective portion at one or more locations on the magnetic body such that the at least one reflective portion reflects the electromagnetic radiation.

98.-99. (canceled)

100. The method of claim 97, wherein positioning the at least one reflective portion comprises positioning a mirror.

101. The method of claim 97, wherein positioning the at least one reflective portion comprises positioning a prism.

102. The method of claim 97, wherein positioning the at least one reflective portion comprises positioning a terminal end of at least one optical fiber.
